(19) United States
(12) Patent Application Publication
(10) Pub. No.: US 2026/0220432 A1
(43) Pub. Date: Jul. 30, 2026

(54) SYSTEM AND METHOD FOR DISCOVERING CASUAL RELATIONSHIPS IN NON-STATIONARY TIME SERIES

(71) Applicant: Robert Bosch GmbH, Stuttgart (DE)

(72) Inventors: Jiageng ZHU, Los Angeles, CA (US); Kehao LI, San Jose, CA (US)

(21) Appl. No.: 19/041,315

(22) Filed: Jan. 30, 2025

(51) Int. Cl. G06N 3/0455; G06N 3/08

(52) U.S. Cl. CPC G06N 3/0455; G06N 3/08

(57) ABSTRACT

A computer-implemented method identifies relationships in non-stationary data utilizing the steps of receiving non-stationary input data comprising information on multiple signals over time, processing the data with an untrained transformer encoder, and initializing prediction tokens, sending tokens through layers to generate attention matrices, through a number of iterations sending the attention matrices are input into a graph generator, which predicts causal graphs that represent relationships between signals and are evaluated based on associated loss, adjusting parameters of the graph generator or prediction model iteratively to minimize loss, and once a threshold is met, output a final causal graph, revealing the relationships in the non-stationary data.

### TECHNICAL FIELD

The present disclosure relates to machine learning models, including those that utilize graph generators.

### BACKGROUND

Time series data, comprising sequences of observations collected over time, are prevalent across various domains. Many real-world time series exhibit non-stationary behavior, meaning their statistical properties evolve over time. This non-stationarity can manifest as trends, seasonality, or structural changes in the underlying data-generating process. In the example of smart cities, non-stationarity can be observed in the relationship between traffic flow and various urban factors. For instance, during typical weekday mornings, there might be a strong correlation between the number of vehicles on the road and the time of day due to rush hour patterns. However, this relationship can change significantly during holidays, major events, or as a result of long-term shifts in urban demographics and infrastructure. The impact of factors such as weather conditions on traffic flow might also vary seasonally or as the city's public transportation system evolves. This dynamic interplay of variables exemplifies non-stationarity in urban time series data.

Causal discovery for non-stationary time series involves identifying and understanding cause-and-effect relationships among variables in data where the underlying causal structure may change over time. This field integrates techniques from time series analysis, causal inference, and machine learning to uncover dynamic causal patterns.

Understanding causal relationships for non-stationary time series data is potential to significantly enhance decision-making processes, optimize system performance, and drive innovation in industries ranging from urban planning and healthcare to environmental science and finance. In healthcare, it can help identify how the influence of various risk factors on patient outcomes changes over time, leading to more personalized and effective treatment strategies. Climate scientists can use these methods to reveal evolving relationships between climate variables, aiding in the understanding of climate change dynamics and improving long-term forecasts. In financial markets, causal discovery techniques can uncover how relationships between economic indicators, company performance metrics, and stock prices shift during different market regimes, providing valuable insights for investors and policymakers.

### SUMMARY

A first illustrative embodiment discloses, a computer-implemented method for identifying relationships in non-stationary data includes the steps of receiving input data, wherein the input data is nonstationary input data that includes information associated with two or more signals and at one or more corresponding time periods, sending the nonstationary input data to a transformer, initializing one or more prediction tokens utilizing at least the one or more embedding dimensions, sending one or more prediction tokens to the one or more layers, wherein each prediction of a token corresponds to a part of a loss, and a sum of al token prediction loss contribute to a total loss associated with training, in response to a loss associated with the one or more layers and the one or more prediction tokens, outputting one or more attention matrices associated with the nonstationary input data, wherein the one or more attention matrices, and for a number of iterations sending the one or more attention matrices to a graph generator, wherein the graph generator is configured to output one or more predicted causal graphs associated with the one or more attention matrices to a prediction model, wherein the one or more predicted causal graphs indicates a relationship between, determining a loss associated with the prediction model, adjusting one or more parameters of the graph generator or the prediction model in response to the loss, and in response to meeting the threshold, outputting a final causal graph associated with the one or more attention matrices.

A second illustrative embodiment discloses a computer-implemented method for identifying relationships in non-stationary data that includes receiving input data, wherein the input data is nonstationary input data that includes information associated with two or more signals and at one or more corresponding time periods; sending the nonstationary input data to a transformer encoder; initializing one or more prediction tokens utilizing at least the one or more embedding dimensions associated with the nonstationary input data; sending the one or more prediction tokens to one or more layers associated with the transformer encoder to identify a loss associated with one or more layers and the one or more prediction tokens; in response to the loss, outputting one or more attention matrices associated with the nonstationary input data; for a number of iterations, sending the one or more attention matrices to a graph generator, wherein the graph generator is configured to output one or more predicted causal graphs associated with the one or more attention matrices to a prediction model, wherein the one or more predicted causal graphs indicates a first set of variables that influence a second set of variables, determining a loss associated with the one or more predicted causal graphs, adjusting one or more parameters of the graph generator or the prediction model in response to the loss, in response to not meeting a threshold associated with one or more predicted casual graphs, repeating above steps associated with the iterations, and in response to meeting the threshold, outputting a final causal graph associated with the one or more attention matrices.

A third illustrative embodiment discloses a system that includes one or more processors programmed to receive input data at the one or more processors, wherein the input data is nonstationary input data that includes information associated with two or more signals and at one or more corresponding time periods, send the nonstationary input data to a transformer associated with a machine learning model, initialize one or more prediction tokens utilizing at least the one or more embeddings output at the machine learning model, send the one or more prediction tokens to one or more self-attention layers associated with the transformer encoder to determine a loss associated with one or more self-attention layers and the one or more prediction tokens, in response to the loss, output one or more attention matrices associated with the nonstationary input data send the one or more attention matrices to a graph generator, wherein the graph generator is configured to output one or more predicted causal graphs associated with the one or more attention matrices to a prediction model, wherein the one or more predicted causal graphs indicates a first set of variables that influence a second set of variables, determine a loss associated with the one or more predicted causal graphs, adjust one or more parameters of the graph generator or the prediction model in response to the loss, and in response to meeting a threshold, output a final causal graph associated with the one or more attention matrices.

### BRIEF DESCRIPTION OF THE DRAWINGS

FIG. 1 illustrates a system for training a neural network, according to an embodiment.

FIG. 2 illustrates a computer-implemented method for training and utilizing a neural network, according to an embodiment.

FIG. 3A illustrates a first stage of training utilizing to obtain an attention matrix.

FIG. 3B illustrates a second stage of training to obtain a causal graph utilizing the attention matrix.

FIG. 4 illustrates an embodiment of a visualization of one or more attention matrices.

FIG. 5 illustrates a schematic diagram of an interaction between a computer-controlled machine and a control system, according to an embodiment.

FIG. 6 illustrates a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 illustrates a schematic diagram of the control system of FIG. 5 configured to control a manufacturing machine, such as a punch cutter, a cutter or a gun drill, of a manufacturing system, such as part of a production line.

FIG. 8 illustrates a schematic diagram of the control system of FIG. 5 configured to control a power tool, such as a power drill or driver, that has an at least partially autonomous mode.

FIG. 9 illustrates a schematic diagram of the control system of FIG. 5 configured to control an automated personal assistant.

FIG. 10 illustrates a schematic diagram of the control system of FIG. 5 configured to control a monitoring system, such as a control access system or a surveillance system.

FIG. 11 illustrates a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The following disclosures and embodiments addresses the challenge of discovering causal relationships in non-stationary multivariate time series data, a critical problem in various domains such as medical research, sensor networks, and traffic analysis. While existing methods primarily assume stationary dynamic systems, real-world scenarios often involve evolving causal relationships. For example, certain real-world events (e.g. unexpected events or occurrences) can often “break” such systems to identify future relationships with a high probability. The system and method described below propose a novel approach that extends the framework of structure learning to handle non-stationary dynamic system. Such a system and method includes a comprehensive framework that incorporates a transformer-based architecture with self-attention mechanisms to capture long-range dependencies. The system may formalize the convergence conditions for non-stationary Granger causality and present a training procedure that employs stochastic masking and Gumbel-Softmax functions for effective learning. Experimental results demonstrate the superior performance of our approach compared to state-of-the-art methods in capturing evolving causal structures. The embodiments disclosed may contribute to more accurate causal discovery in dynamic, non-stationary systems, potentially leading to improved decision-making and predictive capabilities across various applications.

Several methods have been proposed to address the problem of discovering causal relationships in time series data (e.g. nonstationary input data). However, such methods may assume stationary dynamic systems, where the underlying causal mechanism remains consistent over time. In real-world scenarios, this assumption may not always hold true, for example neural connections are time-dependent. The causal relationships among variables can evolve and change over time due to various factors such as regime shifts, external interventions, or inherent non-stationarity in the system dynamics. Ignoring such non-stationarity input can lead to inaccurate causal conclusions and limit the applicability of these methods in practice. Hence, the system and method described below does not ignore such input.

To mitigate the limitations of existing methods, the system and method disclosed below proposes a novel approach for causal discovery in non-stationary multivariate data, such as time series data. The system and method extends the existing framework of structure learning and incorporates self-attention techniques to handle non-stationarity. Specifically, the system may first train a transformer encoder to extract underlying temporal causal information of the given time clip effectively. After that, the system and method may feed the attention matrix derived from the transformer encoder into a graph generator model to generate a causal graph. By learning to correctly predict future time step value along with graph sparsity constraint, the graph generator model in this system and method may be optimized to discover the correct causal graph in a given sample.

The following system and method may be utilized to provide an improved machine learning model that utilizes an attention matrix, along with a graph generator and a light prediction model to output one or more predicted causal graphs to help identify relationships found in non-stationary data, such as time-series data. The causal graphs may help show relationships between signals, such as various sensors within a vehicle and potential impact of different signals over time. The graphs may also be utilized to identify an event that has occurred.

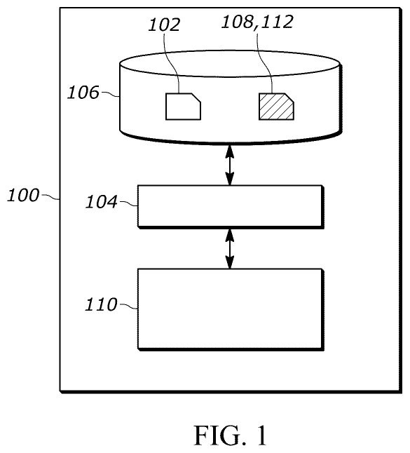

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

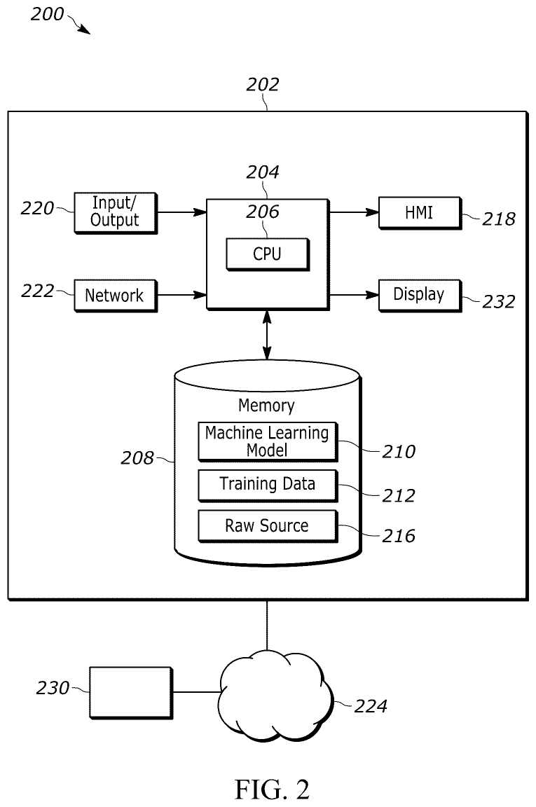

The structure of the system 100 is one example of a system that may be utilized to train the image-to-image machine-learning model and the mixer machine-learning model described herein. Additional structure for operating and training the machine-learning models is shown in FIG. 2.

FIG. 2 depicts a system 200 to implement the machine-learning models described herein, for example the image-to-image machine-learning model, the mixer machine-learning model, and the pre-trained reference model described herein. The system 200 can be implemented to perform future prediction processes described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

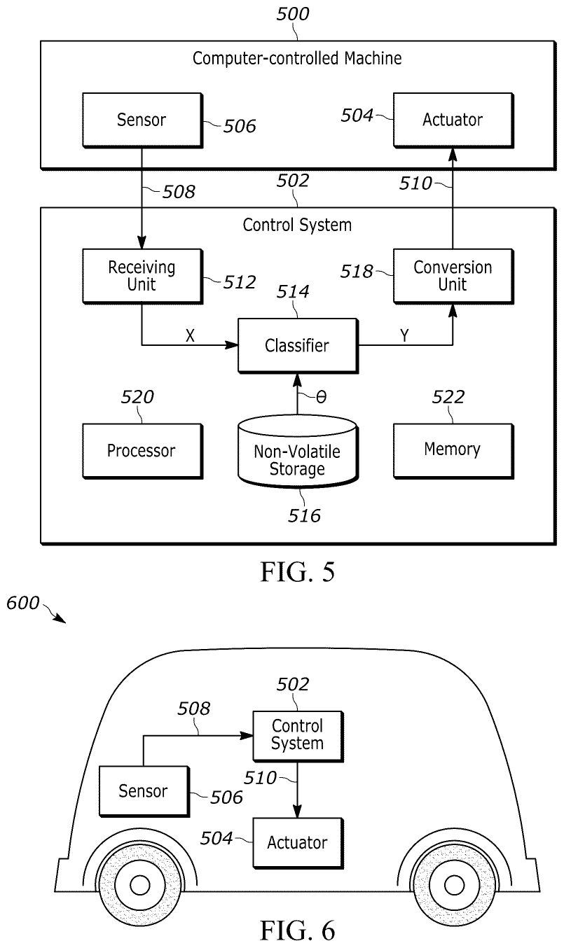

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the image-to-image machine-learning model, the mixer machine-learning model, and the pre-trained reference model described herein.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithms (e.g., image-to-image machine learning model, mixer machine-learning model, and pre-trained reference model) described herein, the output can be a future prediction associated with the input image.

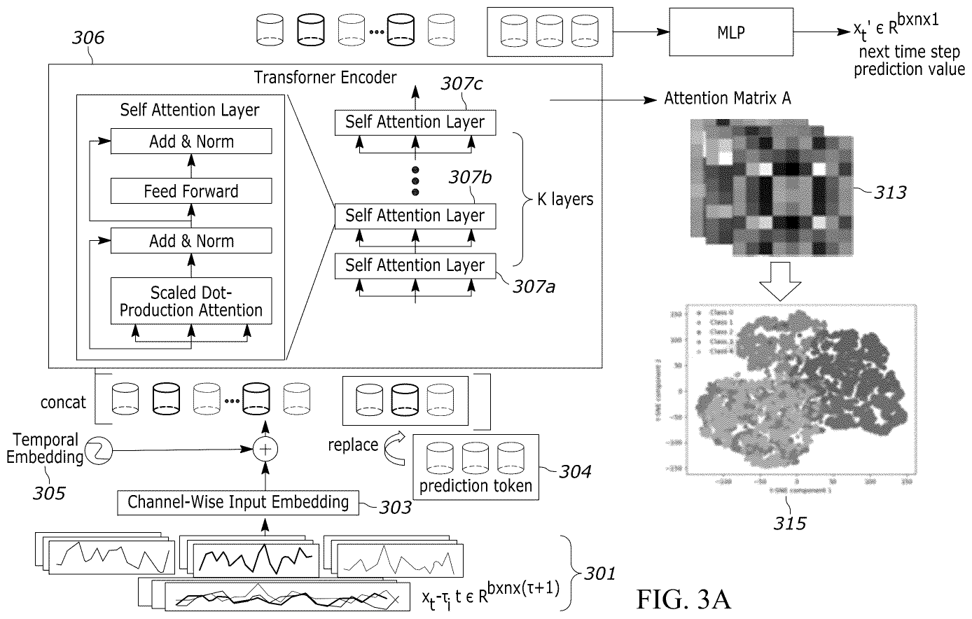

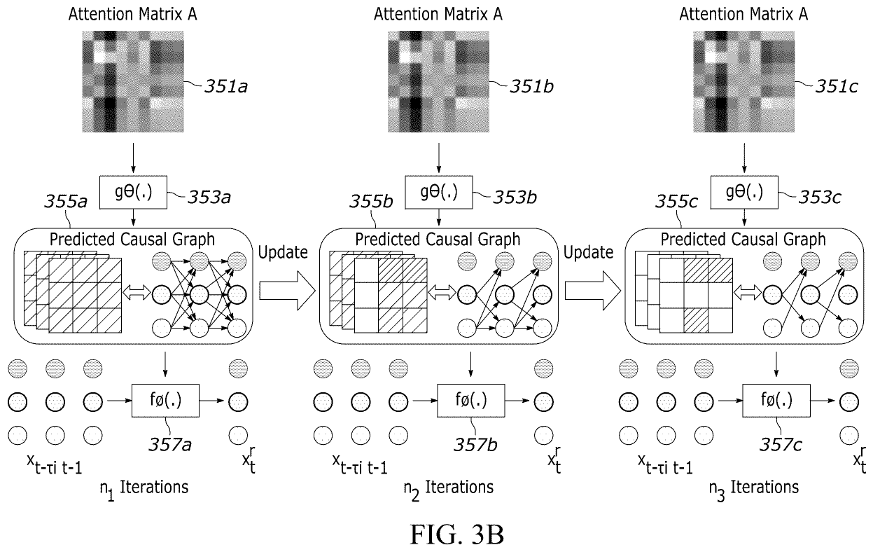

FIG. 3A illustrates and embodiment according to one disclosure of a time-series data. The system and method may include of two stages of training, where the two-stage training pipeline is illustrated in FIG. 3A and FIG. 3B, respectively. In one embodiment, there may be a total of three models to train in the whole pipeline. There may first be a transformer encoder hω(·) which is trained in the first stage. There may be a graph generator g_{θ}(·) which generates the causal graph and trained in the second stage. Last, there may be a lightweight prediction model f_{φ}(·) which is also trained in the second stage.

As illustrated in FIG. 3A, in the first stage, a transformer encoder h_{ω}(·) may be trained to forecast the next time step value by masking the value and requiring the model to predict the next time step value. The transformer encoder takes non-stationary input data 301 (e.g. time series data) as input, denoted as X∈R^{n×(τ+1)}, where τ+1 is sequence length with τ preceding the steps and the current time step. The system may utilize channel-wise input embedding 303 to add a temporal embedding 305 to the input data. This may be utilized to initialize a prediction token. While an encoder may be utilized in one embodiment, the system and method is not limited to an encoder. For example, a machine learning architecture that includes an attention mechanism. Thus, the model can determine an indication of casual relation. Thus in an alternative embodiment, the system can send data to a transformer decoder pre-trained by others, as long as it can generate an attention matrix.

In channel-wise embedding, the system may utilize separate embeddings per channel. Each channel may be processed independently to compute embeddings that focus specifically on the channel's information. The channel-wise embedding may also utilize parallel or sequential modeling. These embeddings may be combined or aggregated in subsequent layers (e.g., concatenation, attention mechanisms, etc.) to form a holistic representation.

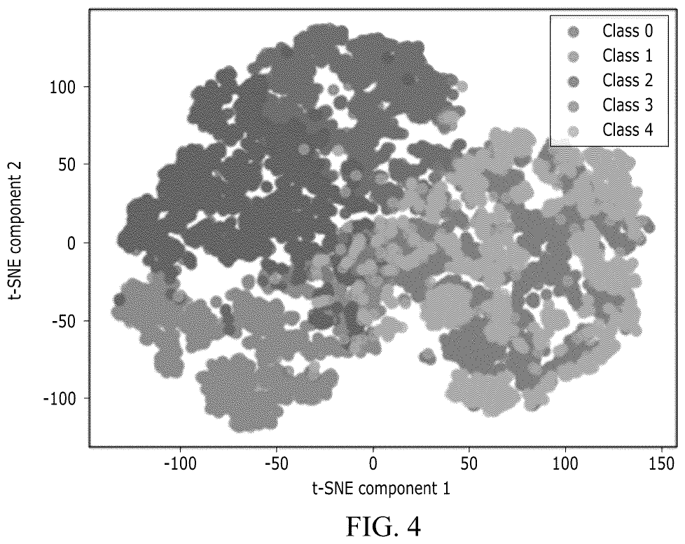

Then, the system may flatten the channel dimension, X∈R^{1×[(τ+1)×n]}. The system may patch a sequence which length at τ+1 in p patches, each patch contains (τ+1)/p data points, which is the patch size of sequence and p<=τ+1. Then the system and method may utilize a linear layer 307a, 307b, 307c to embed each patch of each channel into a different token, finally making the embedding tokens∈R^{m×(p×n)}, where m the embedding dimension. In our following experiment, due to the property of dataset, we set p=τ+1. Therefore, the tokenized Z∈R^{m×[τ+1)×n]}. After embedding, the system and method may add positional embedding for the generated token. Positional encoding is a technique that may be used to inject information about the relative or absolute position of tokens in a sequence into a model. Each color (or shading as shown in the figures) may represent a specific channel from the original time series. This training process implicitly learns the causal information inherent in the input time series sample, which can be represented by the attention matrix 313 of the last self-attention layer 307c. The attention matrix 313 may be denoted as A, where A∈R^{[n×(τ+1)]×[n×(τ+1)]}. The attention matrix 313 from a trained transformer encoder can reveal causal relationships in time series data. During training for future value forecasting, the attention matrix may be utilized to calculate relationships between different time series variables and across various time steps. As a result, the attention matrix in the transformer encoder's self-attention layer can represent the underlying causal connections in the input data. As shown in FIG. 4, two time series segments with the same underlying causal mechanism will produce similar attention matrices. This similarity can be visualized using a TSNE plot 315, where data points representing similar causal mechanisms cluster together. However, this relationship is not actually causality because the attention matrix itself does not provide information about which node is the cause and which node is the effect.

It may be important to note that the attention matrix alone cannot distinguish all different causal mechanisms. However, the system and method may utilize the attention matrix as input to generate a causal graph and refine it using another lightweight prediction neural network.

FIG. 3B illustrates a second stage of training according to an embodiment. In the second stage, the causal graph is discovered by feeding the attention matrices 351a, 351b, 351c into a neural network-based causal probability graph generator 353a, 353b, 353c. The system may utilize a causal graph generator g_{θ}(·) 353a, 353b, 353c which takes the attention matrices 351a, 351b, 351c as input. The outputs of the graph generator 353a, 353b, 353c may then passed through sigmoid function σ(·) and Gumbel function (Gumbel(·)) to produce the predicted causal graph 355a, 355b, 355c. The graph generator g_{θ}(·) can be optimized by predicting future time step values, as shown by the following loss function:

$${G}_{t} = σ ( {g}_{θ} ( {A}_{t - τ : t} ) ) , where {G}_{t} ∈ {R}^{n \times n \times τ}$$

$$\text{?} = {f}_{{ϕ}_{j}} ( {X}_{t - τ : t - 1} ⊙ Gumbel ( {G}_{t} ) )$$

$$L = {\sum }_{t = τ}^{T} {\sum }_{j = 1}^{N} {ℒ}_{2} ( {x}_{t , j} , \text{?} ) + {\sum }_{t = τ}^{T} λ {‖ {G}_{t} ‖}_{1}$$

Where the N is the number of channels of the time series, T is the total length of training sample, \hat{x} is a prediction value, x is a ground-truth value, j is the current prediction channel index, f_{φ}_{ⱼ}(·) is an additional lightweight prediction neural network 357a, 357b, 357c prediction function for channel j, and g_{θ} is graph generation model, σ(·) is Sigmoid function which maps the input value to [0, 1], A_{t-τ:t} is the attention matrix generated by the last self-attention layer of transformer encoder which takes the time clip X_{t-τ:t} as input. To calculate the loss of predicting x_{t,j}, past τ time series value x_{t-τ:t-1} is taken as input.

The loss function may include two parts: (a) A prediction error term:

$${\sum }_{t = τ}^{T} {\sum }_{j = 1}^{N} {ℒ}_{2} ( {x}_{t , j} , \text{?} ) ,$$

and (b) A regularization term: λ∥σ(g_{θ}(A_{t-τ:t}))∥₁. The prediction error may measure how well the model predicts the time series data, while the regularization term encourages sparsity in the Granger causality matrix. σ(g_{θ}(A_{t-τ:t}) is a graph generation model which generated a corresponding causal graph with respect to the input time clip. σ(·) is the sigmoid function, which maps these scores to the range [0, 1], Gumbel(·) is Gumbel-Softmax function that approximate Bernoulli sampling. f_{φ}_{ⱼ}(·) is a prediction neural network 357a, 357b, 357c to predict future values for variable j.

The generated causal probability graph and the raw time series samples are then fed into a prediction network where the causal probability graph may control the message passing in the prediction network. Since the system and method may model the causal graph as a Bernoulli distribution, the system may use the Gumbel-Softmax function to make the discrete distribution differentiable. The Gumbel-Softmax function may be a method that allows gradients to flow through sampling operations, enabling the optimization of discrete random variables in neural networks. By gradually decreasing the Gumbel-Softmax temperature parameter during training, the output will gradually converge to approximating a true Bernoulli distribution, i.e., a true causal graph or a final casual graph. The convergence threshold may be associated with a number of iterations or a threshold loss function. In practice, by utilizing the described training method, the proposed approach outperforms all State-of-The-Art (SOTA) methods in causal discovery for non-stationary data (e.g. time series data).

FIG. 4 illustrates an embodiment of a visualization of one or more attention matrices. In one example, the visualization may be a t-distributed Stochastic Neighbor Embedding (t-SNE). The attention matrices may be different casual mechanisms cluster into distinct groups. However, the attention matrix alone cannot distinguish between samples from Markov Equivalence classes. Markov Equivalence classes may be sets of casual models that have the same statistical properties. The t-SNE visualization graph may show relationships between various classes and the various components utilized, which may be data associated with the signals associated from multiple different sensors. While t-SNE visualization graph is utilize in one embodiment, the system may utilize any type of visualization to show how to divide a matrix into a different glass or group.

To evaluate the model performance and show the superiority of the proposed method, the method may be verified by using Vector Autoregression (VAR) datasets, which model linear interdependencies among multiple time series. In VAR models, each variable is a function of past lags of itself and other variables, allowing for complex interactions and feedback effects. The general form of a VAR(p) model is:

$${X}_{t} = c + {A}_{1} {f}_{1} ( {X}_{t - 1} ) + {A}_{2} {f}_{2} ( {X}_{t - 2} ) + … + {A}_{τ} {f}_{τ} ( {X}_{t - τ} ) + {ϵ}_{t}$$

Where X∈R^{n×(τ+1)} is a time series data, n is number of channels and τ is time lag, Xᵢ is time series data at time step i, c is a constant vector, Aᵢ are coefficient matrices which represent the causal relation at time step i, fᵢ(·) is the nonlinear function and ϵₜ is an error term vector.

Various metrics may be utilized to evaluate the performance of the model. For example, a true positive rate (TPR) may be utilized to evaluate the performance of the model. The TPR may measure the proportion of actual causal relationships correctly identified by the causal discovery method. An actual causal relationship is a genuine cause-and-effect connection between variables that exists in reality or in the ground truth of a dataset. TPR is calculated as the number of correctly identified causal relationships divided by the total number of true causal relationships in the system. That is to say only when the existence of the predicted causal relation and the predicted direction of the causal relations are both correct compared to ground-truth, this prediction is considered true positive. Higher TPR indicates better detection of true causal links, reflecting the method's sensitivity in uncovering the underlying causal structure.

The False Positive Rate (FPR) may be utilized to evaluate the performance of the model. The FPR may measure the proportion of non-causal relationships incorrectly identified as causal by the discovery method. It may be calculated as the number of incorrectly identified causal relationships divided by the total number of non-causal relationships in the system. Lower FPR is desirable, indicating fewer erroneous causal link identifications and thus a lower rate of false discoveries.

The Area Under the Receiver Operating Characteristic Curve (AUC-ROC) may be utilized to evaluate the performance of the model. The AUC-ROC may be utilize to provide an aggregate measure of performance across all classification thresholds. The AUC-ROC may represent the probability that the algorithm ranks a positive instance higher than a negative one. For example, an AUC of 1.0 indicates perfect classification, while 0.5 suggests performance no better than random guessing.

These metrics may offer complementary insights with respect to the various embodiments. For example, TPR may be utilize to assess the ability to detect true causal relationships, FPR evaluates the tendency to infer non-existent causal links, and AUC-ROC provides an overall measure of discriminative power across thresholds. Together, they may enable rigorous assessment and comparison of causal discovery methods in complex, multivariate time series data.

The machine-learning models described herein can be used in many different applications, and not just in the context of road sign image processing. Additional applications where predictions may be used are shown in FIGS. 6-11. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

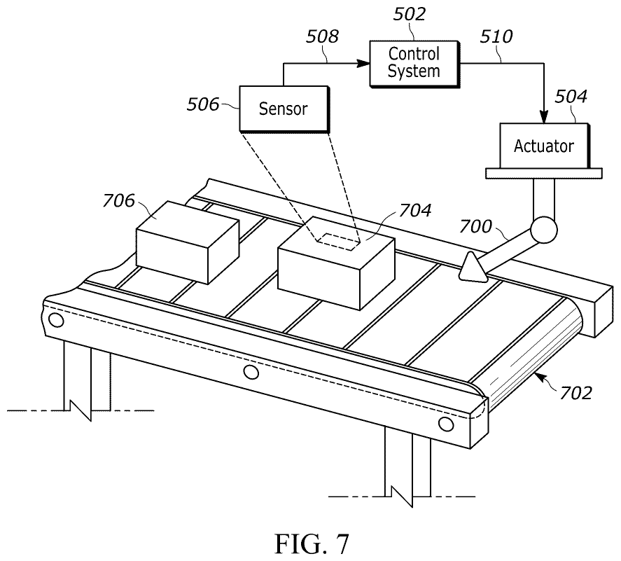

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

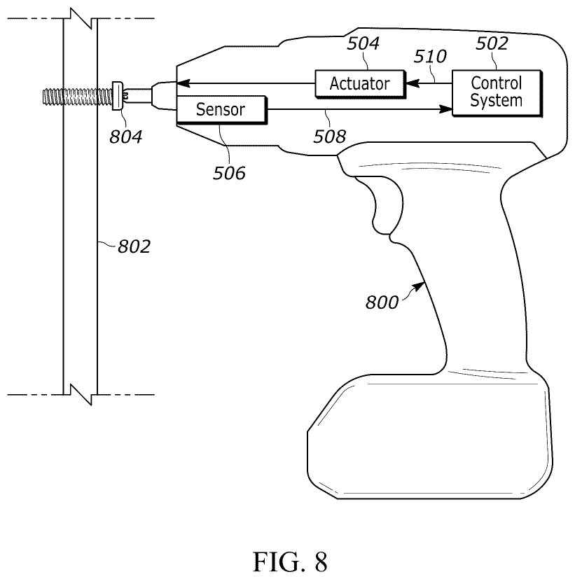

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

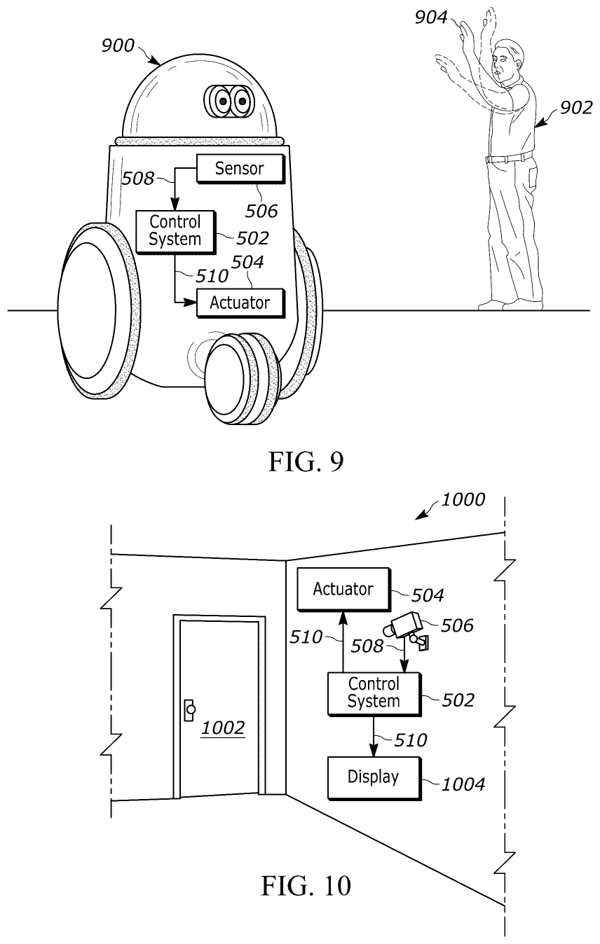

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a future scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

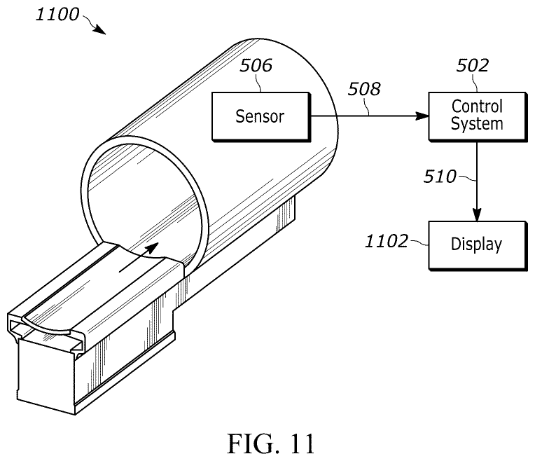

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may utilize an embodiment to predict if a region of a sensed image may become potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A computer-implemented method d for identifying relationships in non-stationary data, comprising:
receiving input data, wherein the input data is nonstationary input data that includes information associated with two or more signals and at one or more corresponding time periods;
sending the nonstationary input data to a transformer associated with a machine learning model;
initializing one or more prediction tokens utilizing at least the one or more embedding representing the one or more prediction tokens;
sending one or more prediction tokens to the one or more layers;
in response to a loss associated with the one or more layers and the one or more prediction tokens, outputting one or more attention matrices associated with the nonstationary input data, wherein the one or more attention matrices indicates at least relationships of signals over time;
for a number of iterations:
(i) sending the one or more attention matrices to a graph generator, wherein the graph generator is configured to output one or more predicted causal graphs to a prediction model, wherein the one or more predicted causal graphs are associated with the one or more attention matrices;
(ii) determining a loss associated with the one or more predicted causal graphs;
(iii) adjusting one or more parameters of the graph generator or the prediction model in response to the loss;
(iv) in response to not meeting a threshold associated with one or more predicted casual graphs, repeating steps (i)-(iii);
(v) in response to meeting the threshold; outputting a final causal graph associated with the one or more attention matrices.

2. The computer-implemented method of claim 1, wherein the method includes utilizing one or more patches each contain data points associated with a sequence length associated with a number of steps associated with the nonstationary input data.

3. The computer-implemented method of claim 1, wherein the method includes flattening one or more channel dimensions associated with the nonstationary input data utilizing the untrained transformer encoder configured to generate one or more patches; and
utilizing one or more linear layers associated with the untrained transformer encoder, embedding each of the one or more patches of each of the one or more channel dimensions to generate one or more embedding dimensions.

4. The computer-implemented method of claim 1, wherein the nonstationary input data is time-series data.

5. The computer-implemented method of claim 1, wherein the transformer associated with the machine learning model includes one or more self-attention layers.

6. The computer-implemented method of claim 1, wherein the threshold is associated with a threshold number of iterations associated with the one or more predicted causal graphs.

7. The computer-implemented method of claim 1, wherein the threshold is associated with a loss threshold associated with a convergence of the one or more predicted causal graphs.

8. The computer-implemented method of claim 1, wherein a predicted casual graph associated with a first iteration includes more nodes with links to other nodes than a predicated causal graph associated with a consequent iteration.

9. The computer-implemented method of claim 1, wherein the loss includes a prediction loss and a sparsity loss.

10. The computer-implemented method of claim 1, wherein the graph generator utilizes at least a sigmoid function or Gumbel function.

11. A computer-implemented method for identifying relationships in non-stationary data, comprising:
receiving input data, wherein the input data is nonstationary input data that includes information associated with two or more signals and at one or more corresponding time periods;
sending the nonstationary input data to a transformer configured to output one or more embeddings;
initializing one or more prediction tokens utilizing at least the one or more embedding associated with the nonstationary input data;
sending the one or more prediction tokens to one or more layers associated with the transformer encoder to identify a loss associated with one or more layers and the one or more prediction tokens, wherein the one or more layers are self-attention layers;
in response to the loss, outputting one or more attention matrices associated with the nonstationary input data;
for a number of iterations:
(i) sending the one or more attention matrices to a graph generator, wherein the graph generator is configured to output one or more predicted causal graphs associated with the one or more attention matrices to a prediction model, wherein the one or more predicted causal graphs indicates a first set of variables that influence a second set of variables;
(ii) determining a loss associated with the one or more predicted causal graphs;
(iii) adjusting one or more parameters of the graph generator or the prediction model in response to the loss;
(iv) in response to not meeting a threshold associated with one or more predicted casual graphs, repeating steps (i)-(iii);
(v) in response to meeting the threshold; outputting a final causal graph associated with the one or more attention matrices.

12. The computer-implemented method of claim 11, wherein the one or more layers includes one or more self-attention layers.

13. The computer-implemented method of claim 11, wherein the one or more attention matrices are output at a final-self-attention layer, wherein the one or more attention matrices indicate causal information associated with the nonstationary input data.

14. The computer-implemented method of claim 11, wherein a predicted casual graph associated with a first iteration includes more nodes with links to other nodes than a predicated causal graph associated with a consequent iteration.

15. The computer-implemented method of claim 11, wherein the loss includes a prediction loss and a sparsity loss.

16. The computer-implemented method of claim 11, wherein the graph generator utilizes at least a sigmoid function or Gumbel function at the graph generator.

17. A system, comprising:
one or more processors programmed to:
receive input data at the one or more processors, wherein the input data is nonstationary input data that includes information associated with two or more signals and at one or more corresponding time periods;
send the nonstationary input data to a transformer associated with a machine learning model;
initialize one or more prediction tokens utilizing at least the one or more embeddings output at the machine learning model;
send the one or more prediction tokens to one or more self-attention layers associated with the transformer encoder to determine a loss associated with one or more self-attention layers and the one or more prediction tokens;
in response to the loss, output one or more attention matrices associated with the nonstationary input data;
for a number of iterations:
(i) send the one or more attention matrices to a graph generator, wherein the graph generator is configured to output one or more predicted causal graphs associated with the one or more attention matrices to a prediction model, wherein the one or more predicted causal graphs indicates a first set of variables that influence a second set of variables;
(ii) determine a loss associated with the one or more predicted causal graphs;
(iii) adjust one or more parameters of the graph generator or the prediction model in response to the loss;
(iv) in response to not meeting a threshold associated with one or more predicted casual graphs, repeat steps (i)-(iii);
(v) in response to meeting the threshold, output a final causal graph associated with the one or more attention matrices.

18. The system of claim 17, wherein the final causal graph indicate a plurality of a first set of nodes linked to one or more nodes to indicate a relationship between one or more signals.

19. The system of claim 17, wherein the processor is further programmed to, in response to the loss, adjust one or more parameters of only the prediction model.

20. The system of claim 17, wherein the processor is programmed to initialize the one or more prediction tokens utilizing channel-wise embedding on the nonstationary input data.

21. (canceled)
